(19) United States
(12) Patent Application Publication
(10) Pub. No.: US 2026/0131866 A1
(43) Pub. Date: May 14, 2026

(54) VEHICLE SUSPENSION

(71) Applicants: Hyundai Motor Company, Seoul (KR); Kia Corporation, Seoul (KR)

(72) Inventors: Jin Ho Bae, Hwaseong-si (KR); Ho Sung Park, Hwaseong-si (KR); Sung Il Kim, Hwaseong-si (KR); Min Goo Im, Hwaseong-si (KR)

(21) Appl. No.: 19/052,677

(22) Filed: Feb. 13, 2025

(30) Foreign Application Priority Data
Nov. 13, 2024 (KR) 10-2024-0161180

(51) Int. Cl. B62K 25/08; B62K 25/04

(52) U.S. Cl. CPC B62K 25/08; B62K 2025/045; B62K 2025/047

(57) ABSTRACT

A vehicle suspension can include a telescopic tube including a fork part and a tube part, where the fork part is configured to support a front wheel while forming a caster angle, where tube part is configured to slide linearly along a longitudinal direction of the fork part, a lower arm configured to support the fork part of the telescopic tube in a vertically movable state relative to a vehicle body, an upper arm configured to support the tube part of the telescopic tube to be rotatable relative to the vehicle body with at least two degrees of freedom, and a steering handle connected to the tube part of the telescopic tube. The vehicle suspension can optionally include a vehicle height adjustment device.

### CROSS-REFERENCE TO RELATED APPLICATIONS

This application is based on and claims priority under 35 U.S.C. 119 to Korean Patent Application No. 10-2024-0161180, filed on November 13, 2024, in the Korean Intellectual Property Office, the disclosure of which is herein incorporated by reference in its entirety.

### TECHNICAL FIELD

The present disclosure relates to a technology for front wheel suspension of a vehicle.

### BACKGROUND

A-micro-mobility refers to a small-sized transportation apparatus powered by eco-friendly energy, typically taking the form of a vehicle with a single front wheel.

In addition, a three-wheeled vehicle refers to a vehicle with a single front wheel.

The present disclosure relates to a technology regarding a front wheel suspension structure that is applicable to, for example, micro-mobility or a three-wheeled vehicle with a single front wheel, as described above.

The foregoing described as the background art is intended merely to aid in the understanding of the background of the present disclosure, and is not intended to mean that the present disclosure falls within the purview of the related art already publicly known, available, or in use.

### SUMMARY

An embodiment of the present disclosure can provide a vehicle suspension that stably supports the front wheel relative to the vehicle body, minimizes changes in a wheelbase during braking to enhance vehicle stability, and reduces rotational friction during steering, thereby advantageously ensuring a sufficient steering angle.

An embodiment of the present disclosure can provide a vehicle suspension that allows a user to easily adjust the vehicle height relative to the front wheel as needed.

The technical subjects pursued in the present disclosure may not be limited to the above-mentioned technical subjects, and other technical subjects that are not mentioned may be clearly understood from the following descriptions by those skilled in the art to which the present disclosure pertains.

In view of the foregoing, a vehicle suspension of an embodiment of the present disclosure can include: at least one telescopic tube including a fork part configured to support a front wheel while forming a caster angle, and a tube part provided to slide linearly along a longitudinal direction of the fork part; a lower arm configured to support the fork part of the telescopic tube in a vertically movable state relative to a vehicle body; an upper arm configured to support the tube part of the telescopic tube to be rotatable relative to the vehicle body with at least two degrees of freedom; and a steering handle connected to the tube part of the telescopic tube.

The at least one telescopic tube may include two telescopic tubes arranged in parallel on left and right sides of the front wheel, respectively, the fork parts of the two telescopic tubes may be connected and supported by a lower stem, the tube parts of the two telescopic tubes may be connected and supported by an upper stem, the lower arm may support the fork parts relative to the vehicle body via the lower stem, and the upper arm supports the tube parts relative to the vehicle body via the upper stem.

The steering handle may be connected to the tube parts of the telescopic tubes through the upper stem.

The lower arm may have a front portion connected to the lower stem via a lower ball joint, and a rear portion fixed to be rotatable in a vertical direction with respect to the vehicle body.

The upper arm may be fixed to the vehicle body and connected to the upper stem via an upper ball joint to support the tube parts to be rotatable relative to the vehicle body with at least two degrees of freedom.

The connection position of the upper arm to the upper stem via the upper ball joint may be located further rearward of the vehicle body than the connection position of the tube parts to the upper stem, and the connection position of the lower arm to the lower stem via the lower ball joint may be located further rearward of the vehicle body than a connection position of the fork parts to the upper stem.

The connection positions of the two tube parts to the upper stem may form an isosceles triangle with a connection position of the upper arm to the upper stem via the upper ball joint as an apex, and the connection positions of the two fork parts to the lower stem may form an isosceles triangle with a connection position of the lower arm to the lower stem via the lower ball joint as an apex.

A damper assembly may be provided between the lower arm and the vehicle body, in which the damper assembly may be configured to provide elastic force and damping force when the lower arm is raised/lowered relative to the vehicle body.

A vehicle height adjustment device may be provided between the lower arm and the vehicle body, in which the vehicle height adjustment device may be configured to adjust the height of the lower arm relative to the vehicle body.

The damper assembly configured to provide elastic force and damping force when the lower arm is raised/lowered relative to the vehicle body and the vehicle height adjustment device configured to adjust the height of the lower arm relative to the vehicle body may be arranged in series between the lower arm and the vehicle body.

The vehicle height adjustment device can include: at least one lift guide provided in the vehicle body; a vehicle height adjustment nut configured to be raised/lowered while being guided by the lift guide, the vehicle height adjustment nut including a nut hole extending vertically therethrough and being connected to the damper assembly; and a vehicle height adjustment bolt rotatably supported relative to the vehicle body and screw-coupled with the nut hole of the vehicle height adjustment nut.

The vehicle height adjustment device further may include a vehicle height locking mechanism configured to fix a raising/lowering position of the vehicle height adjustment nut by the rotation of the vehicle height adjustment bolt.

The vehicle height locking mechanism may include a locking lever configured to vary the width of a slit radially cut in a portion of the nut hole of the vehicle height adjustment nut.

A suspension bracket may be provided between the vehicle height adjustment nut and the damper assembly, in which the suspension bracket may be integrally coupled to the vehicle height adjustment nut and configured to rotatably support an upper end of the damper assembly.

A slide plate may be provided between the vehicle height adjustment nut and the lift guide, in which the slide plate may be integrally fixed to the vehicle height adjustment nut, inserted into the lift guide, and guided by the lift guide.

Two lift guides may be provided and arranged on opposite sides of the vehicle height adjustment nut, holder plates may be respectively provided at upper and lower ends of the lift guides of the opposite sides to rotatably support the vehicle height adjustment bolt, and at least one of the two holder plates may include a bearing configured to support the vehicle height adjustment bolt.

In view of the foregoing, a vehicle height adjustment device of the present disclosure may include: a vehicle height adjustment nut having a nut hole extending vertically therethrough; a vehicle height adjustment bolt screw-coupled with the nut hole of the vehicle height adjustment nut; at least one lift guide configured to guide movement of the vehicle height adjustment nut in response to rotation of the vehicle height adjustment bolt; and a holder plate configured to support rotation of the vehicle height adjustment bolt and to restrict movement of the vehicle height adjustment bolt relative to the lift guide.

The vehicle height adjustment nut may include a slot radially cut in a portion of the nut hole, and the vehicle height adjustment nut may include a locking lever configured to vary the width of the cut slot through rotation.

The lift guide may be arranged to guide opposite sides of the vehicle height adjustment nut, the holder plate may be connected to each of the upper and lower ends of the lift guide, the locking lever may be installed to be exposed through a side opening defined by the lift guide and the holder plate, and a suspension bracket may be installed through the other side opening defined by the lift guide and the holder plate. The suspension bracket may be fixed to the vehicle height adjustment nut and connect the vehicle height adjustment nut to a suspension component.

A slide plate may be inserted into a guide recess formed in the lift guide and coupled to the vehicle height adjustment nut, and the slide plate may be made of a material different from that of the vehicle height adjustment nut.

An embodiment of the present disclosure can provide a vehicle suspension that stably supports the front wheel relative to the vehicle body, minimizes changes in the wheelbase during braking to enhance vehicle stability, and reduces rotational friction during steering, thereby enabling smooth steering operations and advantageously ensuring a sufficient steering angle.

An embodiment of the present disclosure can allow a user to easily adjust the vehicle height relative to the front wheel as needed, thereby facilitating the prevention of vehicle flooding in situations where there is a risk of flooding.

Advantages obtainable from an embodiment of the present disclosure may not be limited to the above-mentioned advantages, and other advantages that are not mentioned may be understood from the following descriptions by those skilled in the art to which the present disclosure pertains.

### BRIEF DESCRIPTION OF THE DRAWINGS

The above and other features and advantages of embodiments of the present disclosure can be more apparent from the following detailed description taken in conjunction with the accompanying drawings, in which:

FIG. 1 is a view illustrating a vehicle to which a vehicle suspension according to an embodiment of the present disclosure is applied;

FIG. 2 is a view illustrating a part of the vehicle body of FIG. 1;

FIG. 3 is a view of the vehicle body of FIG. 2 observed from the front side;

FIG. 4 is a view illustrating a configuration of an embodiment of the present disclosure;

FIG. 5 is an exploded perspective view of FIG. 4;

FIG. 6 is a reference view illustrating the operation and effect of an upper ball joint of an embodiment of the present disclosure;

FIG. 7 is a view illustrating in detail the part where an upper stem is connected to an upper arm by the upper ball joint, according to an embodiment of the present disclosure;

FIG. 8 is a view illustrating an example of a vehicle height adjustment device of an embodiment of the present disclosure; and

FIG. 9 is an exploded perspective view of the vehicle height adjustment device of FIG. 8.

### DETAILED DESCRIPTION OF ILLUSTRATIVE EMBODIMENTS

In describing the example embodiments set forth herein, a detailed description of known functions or configurations incorporated herein can be omitted when it is determined that the description may make the subject matter of the example embodiments set forth herein unclear. It can be appreciated that the accompanying drawings are provided only for the sake of easy understanding of the example embodiments set forth herein, and technical ideas of the present disclosure is not necessarily limited to the accompanying drawings and can include modifications, equivalents, or alternatives falling within the spirit and scopes of the present disclosure.

Terms including an ordinal number such as "a first" and "a second" may be used to describe various elements, but the elements are not necessarily limited by these terms. The above terms can be used merely for the purpose of distinguishing one element from other elements.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

In the case where an element is referred to as being "connected" or "coupled" to any other elements, it can be understood that not only the element may be directly connected or coupled to the other elements, but also another element may exist therebetween. Contrarily, in the case where an element is referred to as being "directly connected" or "directly coupled" to any other element, it can be understood that no other element exists therebetween.

Any number of components or a variety of components in any of the configurations described herein may be included in an embodiment of the disclosure described herein. In an embodiment, the components may include any combination of the features described herein and may be arranged in any of the various configurations described herein. The concepts relating to the structure and arrangement of the components of example embodiments of the present disclosure, as well as their use and operation, may be applied to any number of embodiments in any combination, as well as to the specific embodiments discussed herein. Example embodiments including those having various features in various arrangements are described below with reference to the drawings.

Hereinafter, example embodiments set forth herein will be described in detail with reference to the accompanying drawings, and same or similar elements can be given same and similar reference numerals regardless of figure numbers, so duplicate descriptions thereof can be omitted.

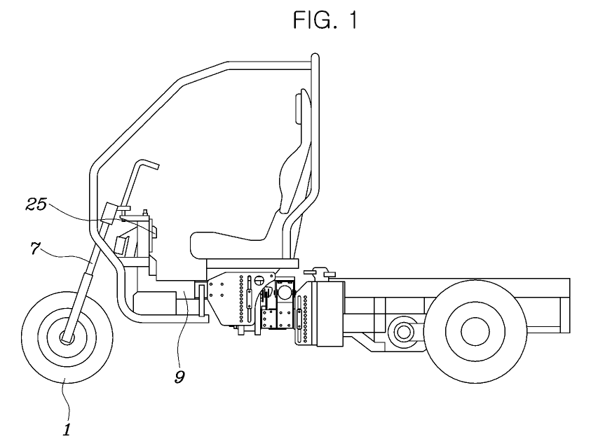

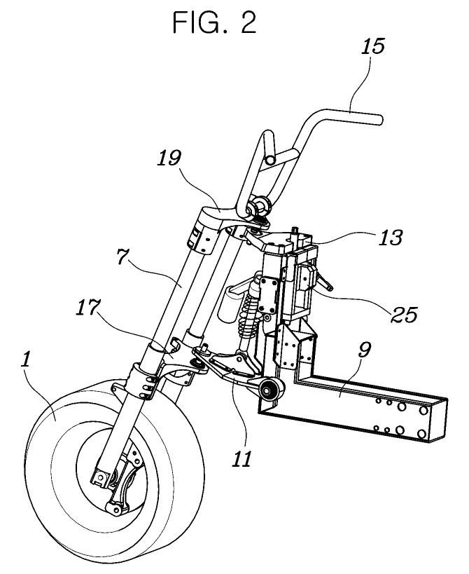

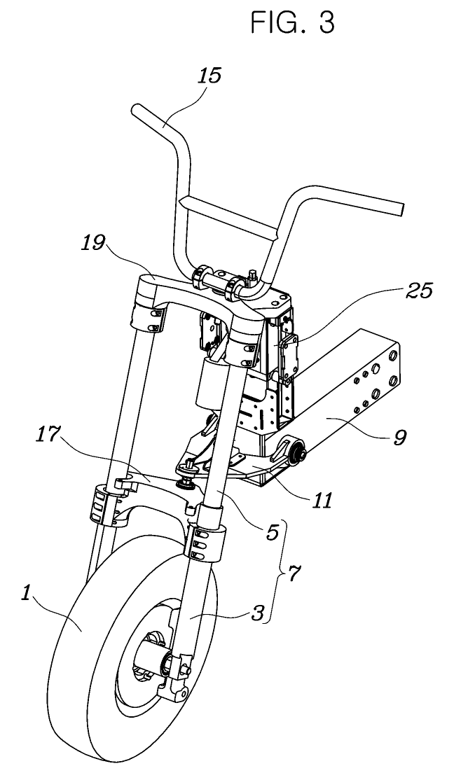

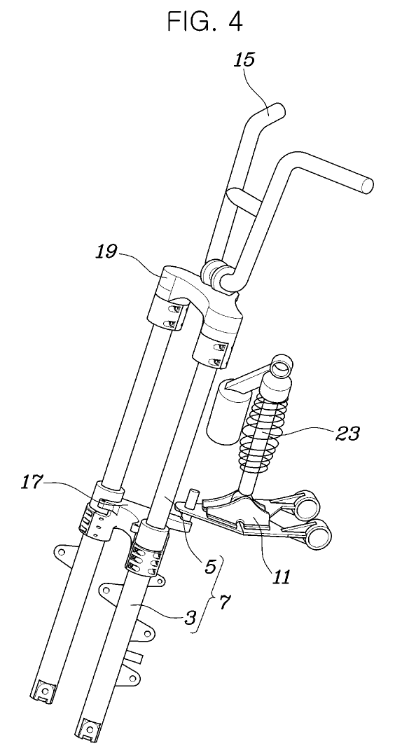

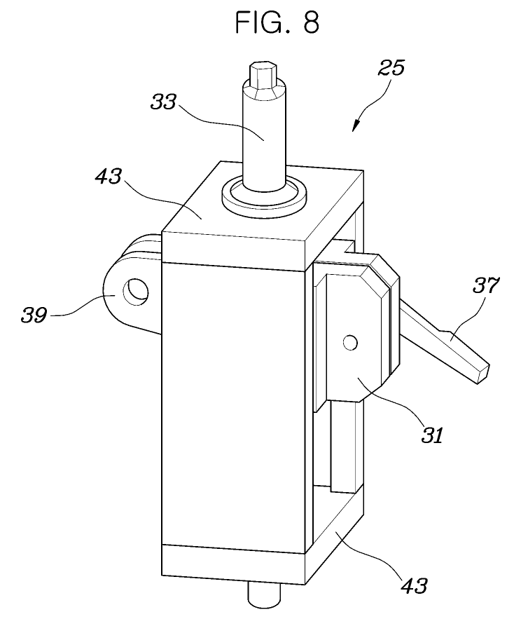

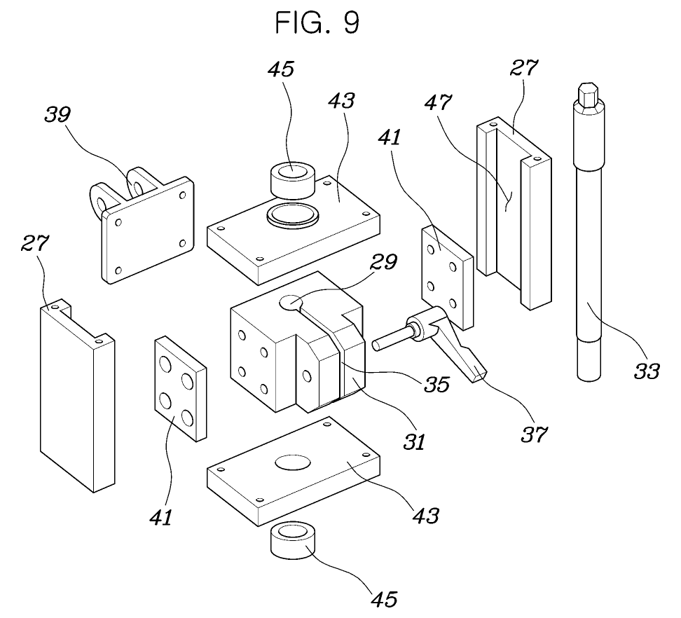

Referring to FIGS. 1 to 9, an example embodiment of a vehicle suspension of the present disclosure can include: at least one telescopic tube 7 including a fork part 3 configured to support a front wheel 1 while forming a caster angle, and a tube part 5 provided to slide linearly along a longitudinal direction of the fork part 3; a lower arm 11 configured to support the fork part 3 of the telescopic tube 7 in a vertically movable state relative to a vehicle body 9; an upper arm 13 configured to support the tube part 5 of the telescopic tube 7 to be rotatable relative to the vehicle body 9 with at least two degrees of freedom; and a steering handle 15 connected to the tube part 5 of the telescopic tube 7.

An embodiment of the present disclosure can be configured such that the vehicle body 9 can be connected to the telescopic tube 7 via the upper arm 13 and the lower arm 11, and the front wheel is rotatably supported on the telescopic tube 7, so that the displacement between the vehicle body 9 and the front wheel 1 can be absorbed by the rotation of the lower arm 11 and the linear sliding of the telescopic tube 7.

In an embodiment of the present embodiment, the telescopic tube 7 can support the front wheel 1 while forming a positive caster angle with respect to the body 9, thereby forming a steering restoring force of the vehicle during the driving of the vehicle.

The upper arm 13 can support the tube part 5 of the telescopic tube 7 to be rotatable relative to the vehicle body 9 with two or more degrees of freedom while being fixed to the vehicle body 9, thereby forming a steering axis during the steering with the steering handle 15, and enabling rotation of the tube part 5 relative to the vehicle body 9 that occurs in response to the up-and-down rotation of the lower arm 11 relative to the vehicle body 9.

In an embodiment of the present embodiment, the at least one telescopic tube 7 can include two telescopic tubes 7 arranged in parallel on left and right sides of the front wheel 1, respectively, the fork parts 3 of the two telescopic tubes 7 can be connected and supported by a lower stem 17, the tube parts 5 of the two telescopic tubes 7 can be connected and supported by an upper stem 19, the lower arm 11 can support the fork parts 3 relative to the vehicle body 9 via the lower stem 17, and the upper arm 13 can support the tube parts 5 relative to the vehicle body 9 via the upper stem 19.

The fork parts 3 of the telescopic tubes 7 can be connected integrally by the lower stem 17 while rotatably supporting the front wheel 1 on opposite sides of the front wheel 1, and the tube parts 5 can be connected integrally by the upper stem 19. Thus, the upper stem 19 and the lower stem 17 can be supported on the vehicle body 9 by the upper arm 13 and the lower arm 11, respectively.

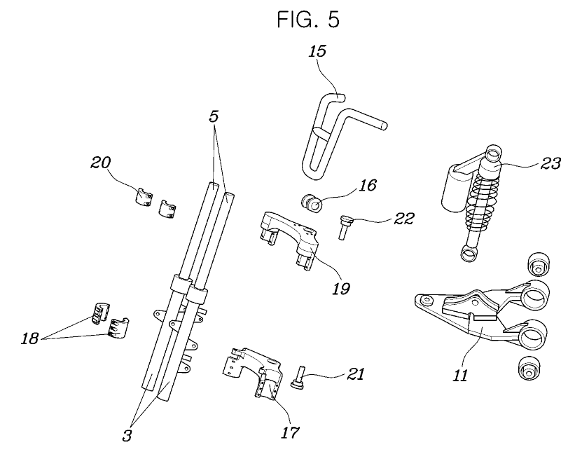

For reference, FIG. 5 also illustrates a lower holder 18 for fixing the fork parts 3 to the lower stem 17 and an upper holder 20 for fixing the tube part 5 to the upper stem 19.

The steering handle 15 can be connected to the tube parts 5 of the telescopic tubes 7 through the upper stem 19.

For reference, FIG. 5 also illustrates a handle fixing holder 16 for fixing the steering handle to the upper stem 19.

The lower arm 11 can have a front portion connected to the lower stem 17 via a lower ball joint 21, and a rear portion fixed to be rotatable in a vertical direction with respect to the vehicle body 9.

The lower arm 11 can be installed to be rotatable relative to the vehicle body 9 with a rotation axis parallel to the transverse direction of the vehicle body 9 to be rotatable up and down with respect to the vehicle body 9, while being connected to the lower stem 17 via the lower ball joint 21 to enable steering by rotation of the lower stem 17 and the fork parts 3 relative to the lower arm 11 and to absorb an angle change between the lower stem 17 and the lower arm 11 that occurs when the front wheel 1 bumps and rebounds.

The upper arm 13 can be fixed to the vehicle body 9 and connected to the upper stem 19 via an upper ball joint 22 to support the tube parts 5 to be rotatable relative to the vehicle body 9 with at least two degrees of freedom.

Therefore, when the upper ball joint 22 connecting the upper arm 13 and the upper stem 19 and the lower ball joint 21 connecting the lower arm 11 and the lower stem 17 are connected to each other, a steering axis can be formed that steers by rotating the front wheel 1 with respect to the vehicle body 9 when steering by the steering handle 15.

The connection position of the upper arm 13 to the upper stem 19 via the upper ball joint 22 can be located further rearward of the vehicle body 9 than the connection position of the tube parts 5 to the upper stem 19, and the connection position of the lower arm 11 to the lower stem 17 via the lower ball joint 21 can be located further rearward of the vehicle body 9 than the connection position of the fork parts 3 to the upper stem 19.

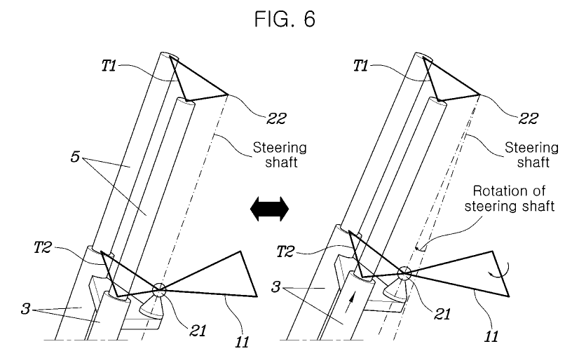

More specifically, referring to FIG. 6, in an embodiment of the present embodiment, the connection positions of the two tube parts 5 to the upper stem 19 can form an isosceles triangle T1 with the connection position of the upper arm 13 to the upper stem 19 via the upper ball joint 22 as an apex, and the connection positions of the two fork parts 3 to the lower stem 17 can form an isosceles triangle T2 with the connection position of the lower arm 11 to the lower stem 17 via the lower ball joint 21 as an apex.

For reference, FIG. 6 is for explaining the effect of the structure in which the upper arm 13 and the upper stem 19 can be connected by the upper ball joint 22 in an embodiment of the present disclosure, and it can be noted that an actual configuration with full tolerances, mechanisms, and dimensions of an embodiment of the present disclosure is not illustrated in the drawing.

FIG. 6 illustrates an isosceles triangle T2 connecting the positions where the two fork parts 3 can be connected to the lower stem 17 and the position of the lower ball joint 21 on a plane perpendicular to the steering axis, and an isosceles triangle T1 connecting the positions where the two tube parts 5 can be connected to the upper stem 19 and the position of the upper ball joint 22 on a plane perpendicular to the steering axis.

The lower arm 11 that can be rotatable up and down relative to the vehicle body 9 and can be connected to the lower stem 17 and the lower ball joint 21 can be indicated by a triangle.

Referring to FIG. 6, based on the drawing on the left, when a bump occurs on the front wheel 1, the fork parts 3 and the lower stem 17 can be raised as illustrated in the drawing on the right. The lower arm 11 connected to the lower stem 17 and the lower ball joint 21 can rotate upward relative to the vehicle body 9, thereby moving the lower stem 17 toward the front of the vehicle body 9, allowing the steering axis to rotate toward the front with respect to the upper ball joint 22.

Accordingly, the upper ball joint 22 can allow rotation of the upper stem 19 centered on the steering axis and rotation of the steering axis caused by the raising and lowering of the lower stem 17 as described above while forming the steering axis, and support the upper stem 19. As a result, the upper ball joint 22 can support the tube parts 5 connected to the upper stem 19 to be rotatable relative to the vehicle body 9 with two or more degrees of freedom.

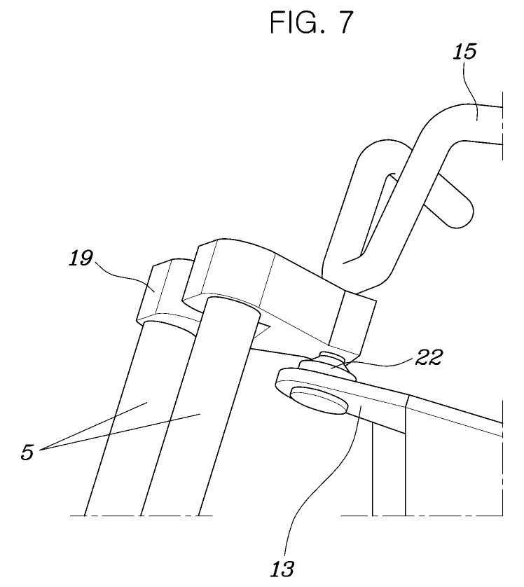

For reference, FIG. 7 illustrates a state in which the upper ends of the tube parts 5 and the steering handle 15 can be fixed to the upper stem 19, and the upper stem 19 can be supported on the upper arm 13 by the upper ball joint 22.

As described above, in an embodiment, when the upper ball joint 22 supports the upper stem 19 and the tube parts 5 with two or more degrees of freedom, smooth rotation of the steering axis maybe ensured regardless of the bump and rebound of the front wheel 1, thereby enabling smooth steering operation when steering by the steering handle 15 and facilitating the ensuring of a sufficient steering angle desired by the driver.

According to an embodiment of the present disclosure, as described above, because the lower stem 17 that fixes the fork parts 3 of the telescopic tubes 7 to be rotatably supported by the lower ball joint 21 while the lower arm 11 is installed to be rotatable relative to the body 9, and the upper ball joint 22 can allow the rotation of the steering shaft itself, when the front wheel 1 moves upward relative to the vehicle body due to braking, the change in the wheelbase is not large, so that the forward rollover of the vehicle can be effectively suppressed.

In an embodiment of the present embodiment, a damper assembly 23 can be provided between the lower arm 11 and the vehicle body 9 to provide elastic force and damping force when the lower arm 11 is raised or lowered relative to the vehicle body 9.

The damper assembly 23 can be installed to provide elastic force and damping force in response to the displacement between the vehicle body 9 and the lower arm 11 that can occur when the lower arm 11 is raised/lowered, and thus can perform the function of absorbing and reducing the shock and vibration transmitted to the vehicle body 9 when the front wheel 1 bumps and rebounds.

A vehicle height adjustment device 25 can be provided between the lower arm 11 and the vehicle body 9, in which the vehicle height adjust device can be capable of adjusting the height of the lower arm 11 relative to the vehicle body 9.

When the vehicle height is adjusted by the vehicle height adjustment device 25, the height of the vehicle body 9 relative to the lower arm 11 can be configured to change.

In an embodiment of the present embodiment, the damper assembly 23 configured to provide elastic force and damping force when the lower arm 11 is raised/lowered relative to the vehicle body 9 and the vehicle height adjustment device 25 configured to adjust the height of the lower arm 11 relative to the vehicle body 9 can be arranged in series between the lower arm 11 and the vehicle body 9.

The vehicle height adjustment device 25 can be fixed to the vehicle body 9, and the portion of the vehicle height adjustment device 25 that is displaced relative to the vehicle body 9 by height adjustment can be configured to be connected to the lower arm 11 via the damper assembly 23.

In an embodiment of the present embodiment, the vehicle height adjustment device 25 can include: at least one lift guide 27 provided on the vehicle body 9; a height adjustment nut 31 that is installed to be capable of being raised/lowered relative to the vehicle body 9 while being guided by the lift guide 27, having a nut hole 29 extending vertically therethrough, and being connected to the damper assembly 23; and a vehicle height adjustment bolt 33 supported to be rotatable relative to the vehicle body 9 and screw-coupled with the nut hole 29 of the vehicle height adjustment nut 31.

Therefore, when the vehicle height adjustment bolt 33 is rotated, the vehicle height adjustment nut 31 can be guided by the lift guide 27 to be raised/lowered, and the displacement of the vehicle height adjustment nut 31 relative to the vehicle body 9 can be transmitted to the lower arm 11 via the damper assembly 23.

The vehicle height adjustment device 25 can include a vehicle height locking mechanism configured to fix the raising/lowering position of the vehicle height adjustment nut 31 by the rotation of the vehicle height adjustment bolt 33.

In an embodiment of the present embodiment, the vehicle height locking mechanism can include a locking lever 37 configured to vary the width of a cut slot 35 radially cut in a portion of the nut hole 29 of the vehicle height adjustment nut 31.

Accordingly, when the locking lever is rotated, the diameter of the nut hole 29 can change, and switching can be performed between a state in which the frictional force between the nut hole 29 and the vehicle height adjustment bolt 33 is appropriately generated by the rotation of the vehicle height adjustment bolt 33, thereby allowing the vehicle height adjustment nut 31 to be smoothly raised/lowered and a state in which the frictional force between the nut hole 29 and the vehicle height adjustment bolt 33 is maximized, thereby restricting the vehicle height adjustment nut 31 from being raised/lowered.

In addition to the above-mentioned configuration, the vehicle height locking mechanism may also be configured with, for example, a configuration that is capable of restraining the rotation of the vehicle height adjustment bolt 33 itself, or a configuration that supports the bottom side of the adjusted vehicle height adjustment nut 31.

Between the vehicle height adjustment nut 31 and the damper assembly 23, a suspension bracket 39 can be provided that can be integrally coupled to the vehicle height adjustment nut 31 and rotatably supports the upper end of the damper assembly 23.

The displacement of the vehicle height adjustment nut 31 can be configured to be transmitted to the damper assembly 23 via the suspension bracket 39.

The vehicle height adjustment nut 31 itself may be configured to implement the function of the suspension bracket 39, but in an embodiment of the present embodiment the vehicle height adjustment nut 31 and the suspension bracket 39 can be configured as separate products, as described above. Therefore, the suspension bracket 39 can be configured to be more durable against the load repeatedly transmitted via the damper assembly 23, and the vehicle height adjustment nut 31 can be configured to be advantageous in terms of screw movement with the vehicle height adjustment bolt 33 and in terms of variable width of the cut slot 35 by the locking lever 37, thereby making it more advantageous in terms of durability and maintenance.

Between the vehicle height adjustment nut 31 and the lift guide 27, a slide plate 41 can be provided that can be integrally fixed to the vehicle height adjustment nut 31, inserted into the lift guide 27, and guided by the lift guide 27.

The slide plate 41 may not be configured as a separate product, but may be configured to allow the vehicle height adjustment nut 31 to be directly guided to the lift guide 27. However, the slide plate 41 may be configured with a separate material that is advantageous for linear sliding operation relative to the lift guide 27 and has excellent durability, making the vehicle height adjustment device 25 ultimately more advantageous in terms of durability and maintenance.

In an embodiment of the present embodiment, two lift guides 27 can be provided and arranged on opposite sides of the vehicle height adjustment nut 31, holder plates 43 can be respectively provided at upper and lower ends of the lift guides 27 of the opposite sides to rotatably support the vehicle height adjustment bolt 33, and at least one of the two holder plates 43 can include a bearing 45 configured to support the vehicle height adjustment bolt 33.

Accordingly, when a user rotates the vehicle height adjustment bolt 33, the vehicle height adjustment bolt 33 can be supported by the bearing 45 and rotate smoothly to raise/lower the vehicle height adjustment nut 31, thereby ultimately smoothly adjusting the height of the vehicle body 9 relative to the lower arm 11 connected via the damper assembly 23, and fixing the vehicle height in a stable state by rotating the locking lever 37 once the vehicle height is adjusted.

For reference, the vehicle height adjustment bolt 33 may be manually rotated by the user using a tool such as a wrench.

When the height vehicle adjustment function is used, flooding of the vehicle may be prevented by raising the vehicle height, for example, in a situation where the vehicle passes through an area with a high risk of flooding.

The vehicle height adjustment device of an embodiment of the present disclosure as described above may be expressed as follows.

An embodiment of the vehicle height adjustment device of the present disclosure can include: a vehicle height adjustment nut 31 having a nut hole 29 extending vertically therethrough; a vehicle height adjustment bolt 33 screw-coupled with the nut hole 29 of the vehicle height adjustment nut 31; at least one lift guide 27 provided to guide movement of the vehicle height adjustment nut 31 according to rotation of the vehicle height adjustment bolt 33; and a holder plate 43 provided to support rotation of the vehicle height adjustment bolt 33 and restrain movement of the vehicle height adjustment bolt 33 relative to the lift guide 27.

The vehicle height adjustment nut 31 can include a slot 35 cut radially in a portion of the nut hole 29, and the vehicle height adjustment nut 31 can include a fixing lever 37 configured vary the width of the cut slot 35 through rotation.

The lift guide 27 can be disposed to guide opposite sides of the vehicle height adjustment nut 31. The holder plate 43 can be connected to each of the upper and lower ends of the lift guide 27. The locking lever 37 can be installed to be exposed through one side opening defined by the lift guide 27 and the holder plate 43. A suspension bracket 39 can be installed to pass through the other side opening defined by the lift guide 27 and the holder plate 43. The suspension bracket 39 can be fixed to the vehicle height adjustment nut 31 and connect the vehicle height adjustment nut 31 to a suspension component.

A slide plate 41 inserted into a guide recess 47 formed in the lift guide 27 can be coupled to the vehicle height adjustment nut 31, and the slide plate 41 can be made of a material different from that of the vehicle height adjustment nut 31.

Although example embodiments of the present disclosure has been described and illustrated, it can be apparent to those skilled in the art that various improvements and modifications may be made to the example embodiments of the present disclosure without departing from technical ideas of the present disclosure defined by the appended claims.

What is claimed is:

1. A vehicle suspension comprising:
at least one telescopic tube, wherein each of the at least one telescopic tube comprises:
a fork part configured to support a front wheel while forming a caster angle, and
a tube part configured to slide linearly along a longitudinal direction of the fork part;
a lower arm configured to support the fork part of the at least one telescopic tube in a vertically movable state relative to a vehicle body;
an upper arm configured to support the tube part of the at least one telescopic tube to be rotatable relative to the vehicle body with at least two degrees of freedom; and
a steering handle connected to the tube part of the at least one telescopic tube.

2. The vehicle suspension of claim 1, wherein the at least one telescopic tube comprises two telescopic tubes arranged in parallel on left and right sides of the front wheel, respectively,
wherein the fork part of each of the two telescopic tubes is connected and supported by a lower stem,
wherein the tube part of each of the two telescopic tubes is connected and supported by an upper stem,
wherein the lower arm supports the fork part of each of the two telescopic tubes relative to the vehicle body via the lower stem, and
wherein the upper arm supports the tube part of each of the two telescopic tubes relative to the vehicle body via the upper stem.

3. The vehicle suspension of claim 2, wherein the steering handle is connected to the tube part of each of the two telescopic tubes through the upper stem.

4. The vehicle suspension of claim 2, wherein the lower arm includes a front portion connected to the lower stem via a lower ball joint, and wherein the lower arm includes a rear portion coupled to be rotatable in a vertical direction with respect to the vehicle body.

5. The vehicle suspension of claim 4, wherein the upper arm is fixed to the vehicle body and wherein the upper arm is connected to the upper stem via an upper ball joint to support the tube part of each of the two telescopic tubes to be rotatable relative to the vehicle body with at least two degrees of freedom.

6. The vehicle suspension of claim 5, wherein a first connection position of the upper arm to the upper stem via the upper ball joint is located further rearward of the vehicle body than a second connection position of the tube part of each of the two telescopic tubes to the upper stem, and
wherein a third connection position of the lower arm to the lower stem via the lower ball joint is located further rearward of the vehicle body than a fourth connection position of the fork part of each of the two telescopic tubes to the upper stem.

7. The vehicle suspension of claim 6, wherein the second connection position of the tube part of each of the two telescopic tubes to the upper stem form a first isosceles triangle with the first connection position of the upper arm to the upper stem via the upper ball joint as a first apex of the first isosceles triangle, and
wherein the fourth connection position of the fork part of each of the two telescopic tubes to the lower stem form a second isosceles triangle with the third connection position of the lower arm to the lower stem via the lower ball joint as a second apex of the second isosceles triangle.

8. The vehicle suspension of claim 5, further comprising a damper assembly disposed between the lower arm and the vehicle body, wherein the damper assembly is configured to provide elastic force and damping force in response to the lower arm being raised and lowered relative to the vehicle body.

9. The vehicle suspension of claim 5, further comprising a vehicle height adjustment device disposed between the lower arm and the vehicle body, wherein the vehicle height adjustment device is configured to adjust a height of the lower arm relative to the vehicle body.

10. The vehicle suspension of claim 9, further comprising a damper assembly disposed between the lower arm and the vehicle body, wherein the damper assembly is configured to provide elastic force and damping force in response to the lower arm being raised and lowered relative to the vehicle body, wherein the damper assembly and the vehicle height adjustment device are arranged in series between the lower arm and the vehicle body.

11. The vehicle suspension of claim 10, wherein the vehicle height adjustment device comprises:
at least one lift guide provided in the vehicle body;
a vehicle height adjustment nut configured to be raised and lowered while being guided by the lift guide, wherein the vehicle height adjustment nut includes a nut hole extending vertically therethrough; and
a vehicle height adjustment bolt rotatably supported relative to the vehicle body and screw-coupled with the nut hole of the vehicle height adjustment nut.

12. The vehicle suspension of claim 11, wherein the vehicle height adjustment device further comprises a vehicle height locking mechanism configured to fix a raising and lowering position of the vehicle height adjustment nut by the rotation of the vehicle height adjustment bolt.

13. The vehicle suspension of claim 12, wherein the vehicle height locking mechanism comprises a locking lever configured to vary a width of a slit radially cut in a portion of the nut hole of the vehicle height adjustment nut.

14. The vehicle suspension of claim 11, further comprising a suspension bracket disposed between the vehicle height adjustment nut and the damper assembly, wherein the suspension bracket is fixed relative to the vehicle height adjustment nut and configured to rotatably support an upper end of the damper assembly.

15. The vehicle suspension of claim 11, further comprising a slide plate disposed between the vehicle height adjustment nut and the lift guide, wherein the slide plate is configured to be fixed relative to the vehicle height adjustment nut, inserted into the lift guide, and guided by the lift guide.

16. The vehicle suspension of claim 11, wherein the at least one lift guide comprises two lift guides arranged on opposite sides of the vehicle height adjustment nut,
wherein two holder plates are respectively provided at upper and lower ends of the two lift guides of the opposite sides to rotatably support the vehicle height adjustment bolt, and
wherein at least one of the two holder plates includes a bearing configured to support the vehicle height adjustment bolt.

17. A vehicle height adjustment device comprising:
a vehicle height adjustment nut having a nut hole extending vertically therethrough;
a vehicle height adjustment bolt screw-coupled with the nut hole of the vehicle height adjustment nut;
a lift guide configured to guide movement of the vehicle height adjustment nut in response to rotation of the vehicle height adjustment bolt; and
a holder plate configured to support rotation of the vehicle height adjustment bolt and to restrict movement of the vehicle height adjustment bolt relative to the lift guide.

18. The vehicle height adjustment device of claim 17, wherein the vehicle height adjustment nut comprises a slot radially cut in a portion of the nut hole, and wherein the vehicle height adjustment nut comprises a locking lever configured to vary a width of the slot through rotation of the locking lever.

19. The vehicle height adjustment device of claim 18, wherein the lift guide is arranged to guide opposite sides of the vehicle height adjustment nut,
wherein the holder plate is connected to each of an upper end and a lower end of the lift guide,
wherein the locking lever is installed to be exposed through a first side opening defined by the lift guide and the holder plate, and
wherein a suspension bracket is installed through a second side opening defined by the lift guide and the holder plate, wherein the suspension bracket is fixed relative to the vehicle height adjustment nut and connects the vehicle height adjustment nut to a suspension component.

20. The vehicle height adjustment device of claim 18, further comprising a slide plate inserted into a guide recess formed in the lift guide and coupled to the vehicle height adjustment nut, wherein the slide plate is made of a material different from that of the vehicle height adjustment nut.
